(19) United States
(12) Patent Application Publication
(10) Pub. No.: US 2007/0130527 A1
(43) Pub. Date: Jun. 7, 2007

(54) Method for transmitting multimedia note using concept of groupware and system therefor

(75) Inventor: Hong-Sik Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: EHOM Inc., Kangnam-gu (KR)

(21) Appl. No.: 11/585,686

(22) Filed: Oct. 24, 2006

(30) Foreign Application Priority Data
Oct. 25, 2005 (KR) 10-2005-0100671

(51) Int. Cl. G06F 17/00; G06F 3/00; G06F 9/00

(52) U.S. Cl. 715/752

(57) ABSTRACT

A method for transmitting a multimedia note using a concept of groupware and a system therefore are provided. A method for transmitting a note between users in a groupware service system environment within cyberspace based on an Internet network includes: accessing, by a user, a web server of a groupware service system via the Internet to log on to the system; and performing e-mail-style multimedia note transmission service having a source editing function to send, at one time, a multimedia note to other users in a group to which the user belongs. Therefore, information can be transmitted and received in real time, as in an instant messaging program, a large-quantity of information can be sent to a group to which a user belongs, and spam mail can be effectively blocked.

### BACKGROUND OF THE INVENTION

1. Field of the Invention

The present invention relates to a method for transmitting a multimedia note using a concept of groupware and a system therefor, and more particularly, to a method for transmitting a multimedia note using a concept of groupware and a system therefor, which allow a user to transmit and receive information in real time like an instant messaging program, and to send a large quantity of information to a group to which the user belongs, and which can effectively block spam mail, by combining a source editing function of an e-mail service, the maneuverability of an instant messaging program, and a mass delivery function of groupware.

2. Description of the Related Art

With the recent development of the Internet, there has been an increase in users who use Internet-based mail, i.e., e-mail.

A system that provides such an e-mail service is composed of an Internet server having an Internet homepage which provides the e-mail service, a mail server for transmitting and receiving mail, and a database for storing mail data transmitted/received by the mail server. When a sender accesses the Internet server, composes a mail and sends it through the mail server, this mail is stored in the database. A recipient is allowed to view the content of the mail by accessing the Internet server and then retrieving the data of the mail stored in the database.

However, with such conventional e-mail services, users cannot send a desired message in real time. Further, various spam mail inconveniences users.

To solve these problems associated with e-mail service, instant messaging programs having several functions including real-time message and file transmission and reception, on-line chatting, etc., have been developed and distributed.

The instant messaging programs are client software that notifies a user when contacts in a list created in advance by the user are logged on to the network and when they send a message to the user.

Instant messaging programs play a central role in e-mail services because of their several functions and convenience of use.

Functions of instant messaging programs include an e-mail transmitting/receiving function which allows a user to transmit and receive e-mail, a file transmission function which promptly sends desired files, a 1:1 chat room function which allows a user to chat with contacts in real time, and a group function which allows a user to meet other users having similar hobbies, interests, or belonging to the same club or alumni association.

However, such instant messaging programs are used primarily by young netizens. Older users and those with less developed keyboarding skills have difficulty in becoming accustomed to an instant messaging program information delivery mode. Further, the instant messaging programs cannot selectively send a large quantity of information to a target group of users at one time in a 1:1 delivery mode.

### SUMMARY OF THE INVENTION

Accordingly, it is an object of the present invention to provide a method for transmitting a multimedia note using a concept of groupware and a system therefor, which allow a user to transmit and receive information in real time like an instant messaging program, and to send a large quantity of information to a group to which the user belongs, and which can effectively block spam mail, by combining a source editing function of an e-mail service, the maneuverability of an instant messaging program, and a mass delivery function of groupware.

A first aspect of the present invention provides a method for transmitting a note between users in a groupware service system environment within cyberspace based on an Internet network, the method comprising: (a) accessing, by a user, a web server of a groupware service system via the Internet to log on to the system; and (b) performing e-mail-style multimedia note transmission service having a source editing function to send, at one time, a multimedia note to other users in a group to which the user belongs.

A second aspect of the present invention provides a system for transmitting notes between users in a groupware service system environment within cyberspace based on an Internet network, the method comprising: (a) a user authenticating unit for allowing a user to access a web server of a groupware service system via the Internet and to log on to the system; and (b) a service providing unit for performing e-mail-style multimedia note transmission service having a source editing function to send, at one time, a multimedia note to other users in a group to which the user belongs.

### BRIEF DESCRIPTION OF THE DRAWINGS

FIG. 1 illustrates the configuration of a system for implementing a method for transmitting a multimedia note using a concept of groupware according to an exemplary embodiment of the present invention; and

FIGS. 2 to 14 illustrate Internet web pages for explaining a method for transmitting a multimedia note using a concept of groupware according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. For the sake of clarity and conciseness, matters related to the present invention which are well-known among those of skill in the art will not be described.

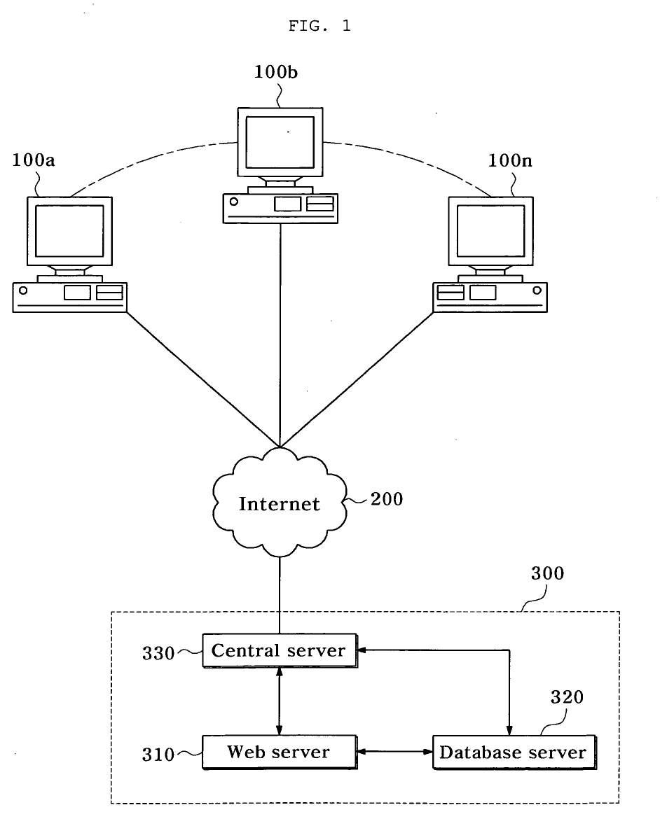

FIG. 1 illustrates the configuration of a system for implementing a method for transmitting a multimedia note using a concept of groupware according to an exemplary embodiment of the present invention.

Referring to FIG. 1, a system for implementing a method for transmitting a multimedia note using a concept of groupware according to an exemplary embodiment of the present invention includes a number of user terminals 100a to 100n connected to a groupware-type note service system 300 for multimedia note transmission via the Internet 200.

The note service system 300 can perform a multimedia note transmission service by which a user sends, at one time, a large quantity of multimedia notes in the form of mail having a source editing function to other users in a group to which the user belongs via the Internet 200, and includes a web server 310 for displaying a web page on a web browser of the user terminals 100a to 100n in response to the user's selection, a database server 320 for storing a message and user information received from the user via the web server 310, and a central server 320 for controlling overall operation of the note service system 300.

Various messages, user information, user group information, and the like, as well as authentication data for each user and group, may be stored in the database server 320 for the multimedia note transmission service.

As described above, in a groupware service system environment within cyberspace based on the Internet 200, a user accesses and logs onto the web server 310 of the groupware-type note service system 300 via the Internet 200, and executes the multimedia note transmission service to send, at one time, a large quantity of multimedia notes in the form of mail having a source editing function to other users in a group to which the user belongs.

A method for authenticating users and their group or a method for grouping users to perform note transmission using a concept of groupware according to an exemplary embodiment of the present invention is performed in the same way as methods disclosed in Korean Patent Application No. 2003-0006423 entitled “APPLYING SYSTEM OF E-CRM AND COMMUNITY USING CONCEPT OF HOME GROUP WARE” and Korean Patent Application No. 2004-0033574 entitled “DATABASE INTERLINKING SYSTEM FOR PROVIDING COMMUNITY IN CYBERSPACE,” filed by the present applicant. The same applies to groups (e.g., churches, apartment complexes, local autonomous entities, schools, and academies) as well as various companies, as a family community is built, for example, in cyberspace.

When members in the group use a multimedia note corresponding to a town, they can quickly and efficiently deliver information to individuals not belonging to the town, as well as to town members, through a real-time interlinking algorithm, by targeting, grouping, and pushing a database (DB). This can simultaneously satisfy groupware, customer relation management (CRM) and supply chain management (SCM) functions, and greatly contribute to increasing cost efficiency and speed.

A method for transmitting a multimedia note according to an exemplary embodiment of the present invention will now be described in detail.

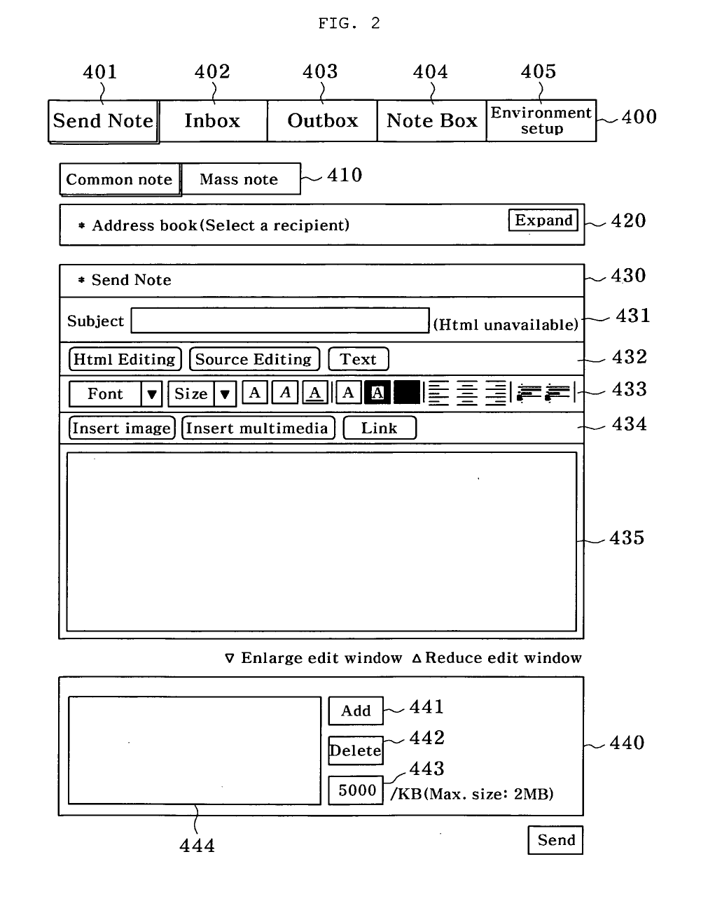

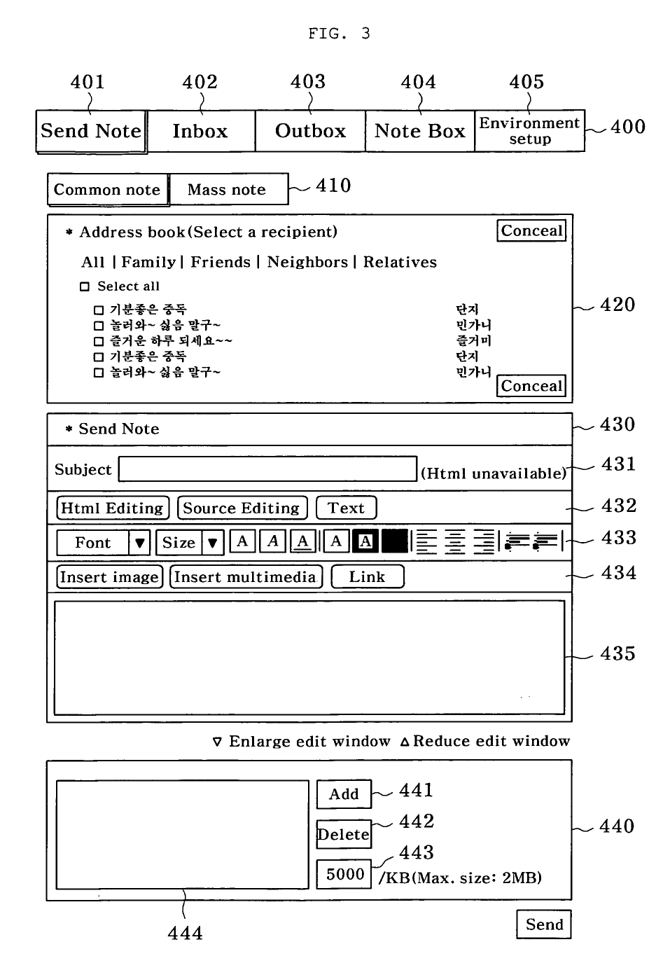

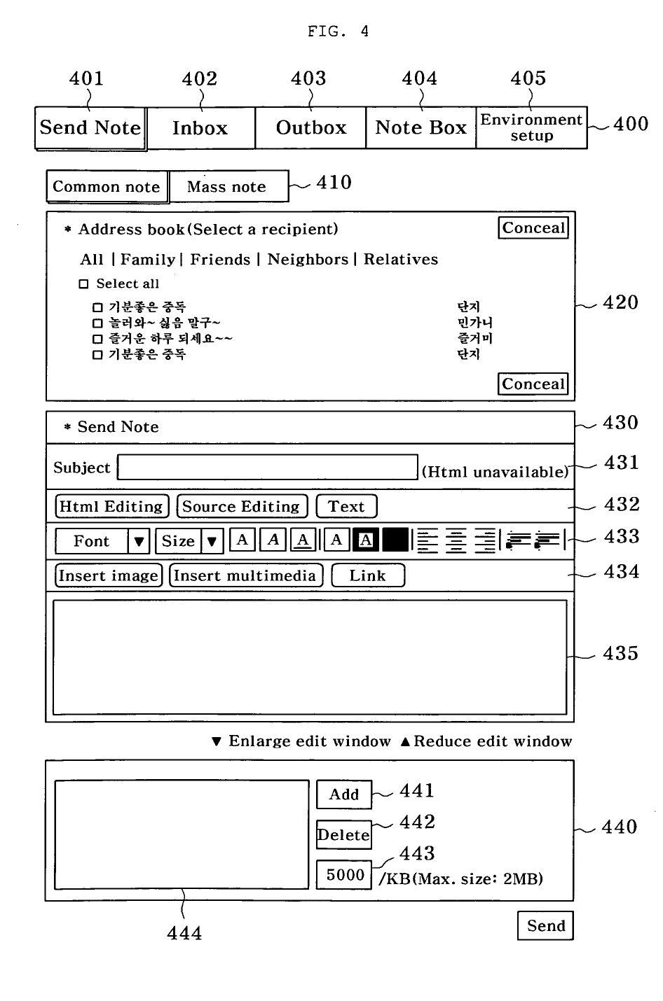

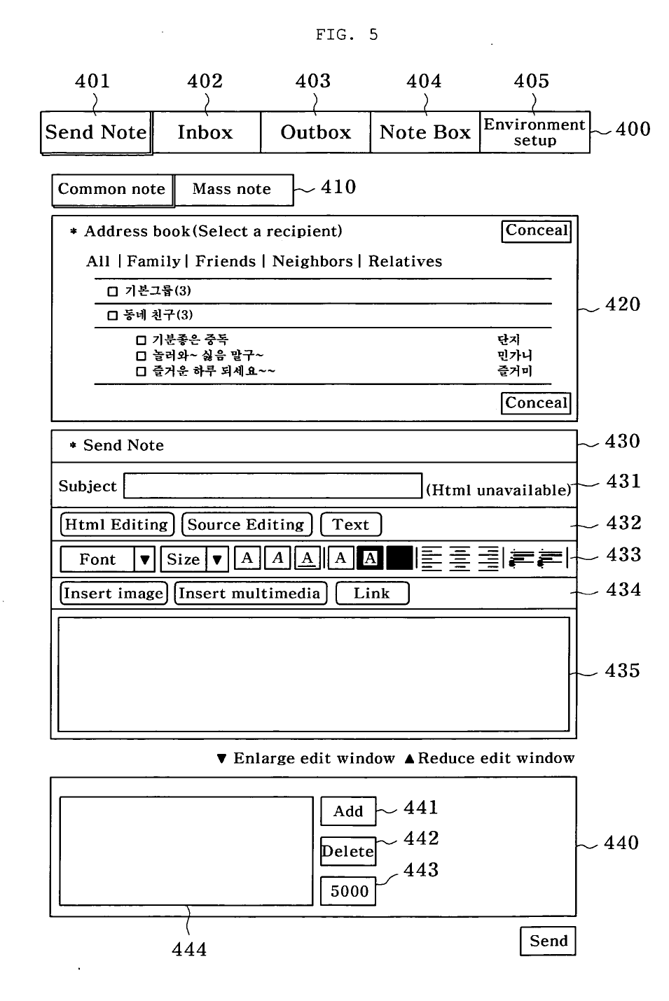

FIGS. 2 to 14 illustrate Internet web pages for explaining a method for transmitting a multimedia note using a concept of groupware according to an exemplary embodiment of the present invention. An initial Internet web page screen, which is displayed on the user terminals 100a to 100n accessing the web server 310 of the note service system 300 according to the present invention, includes a menu selection window 400, a note-mode selection window 410, an address-book management window 420, a Send Note edit window 430, and an attached-file management window 440.

The menu selection window 400 may include activation buttons such as a Send Note button 401 for allowing a user to selectively send a desired message, i.e., a multimedia note, to a number of predetermined groups, an Inbox button 402 for managing notes received from other users in a group to which the user belongs, an Outbox button 403 for managing notes sent by the user, a Note Box button 404 for storing received notes or sent notes that are selected by the user, and an Environment setup button 405 for setting up various service environments.

The note-mode selection window 410 may include a General-Note button 411 for sending multimedia notes in the form of mail having normal text, source editing, and HTML editing functions, and attaching and sending files stored in storage units of the user terminals 100a to 100n; and a Mass-note button 412 for sending multimedia notes in the form of mail having normal text, source editing, and HTML editing functions, and attaching and sending mass files stored in an Internet storage unit of the note service system 300.

The address-book management window 420 displays, on a group-by-group basis, a list of other users in the group to which the user belongs, which are authenticated by the note service system 300.

The Send Note edit window 430 may include a note-content subject input window 431 for inputting a subject for the contents of a note to be sent, an editing-mode selection window 432 for selecting one of editing modes for the contents of the note, a note-content editing-menu window 433 for editing the contents of the note, a function-menu window 434 for adding various functions to the contents of the note, and a note-content input window 435 for inputting the contents of the note.

The editing-mode selection window 432 includes an HTML editing button 432-1 for editing the contents of the note to be sent in an HTML format, a Source edit button 432-2 for editing the contents of the note in a source format, and a Text button 432-3 for editing the contents of the note in a text format.

The note-content editing-menu window 433 includes various function keys for changing font, size, style, and color of various characters used in typical word processing software (e.g., Hangul Word Processor, MS Word, etc.), as well as letter format.

The function-menu window 434 includes an Insert Image button 434-1 for inserting various images into the contents of a note to be sent, an Insert Multimedia button 434-2 for inserting various multimedia into the contents of the note, and a Link button 434-3 for linking a desired web page to the contents of the note.

The attached-file management window 440 includes an Add button 441 for attaching files stored in storage units (e.g., a hard disk, a portable storage unit, etc.) of the user terminals 100a to 100n, a Delete button 442 for deleting the attached files, a file-size display window 443 for displaying the size of the attached files, and an attached-file list window 444 for displaying a list of the attached files.

FIGS. 2 to 5 illustrate Internet web pages displayed when a common-note mode of a Send Note menu is selected according to an exemplary embodiment of the present invention, in which a user accessing the note service system 300 selects the common-note mode to send mass common notes to other users in a group at the same time.

Referring to FIGS. 2 to 5, when a user accesses the web server 310 and clicks on a web-note select area (not shown) on the web page, a main web-note window like that shown in FIG. 2 is displayed.

The user selects a Send Note button 401 of the menu selection window 400 and then selects a Common-Note button 411 of the note-mode selection window 410 to send a large quantity of desired common notes to any predetermined group of users.

When the user selects an Expand button of the address-book management window 420, a list of other users in the group to which the user belongs is displayed on the basis of a group (e.g., all, family, friend, neighbor, relative, etc.), so that the user can select from the list. After selecting all or some of the members in the group to which a desired multimedia note is to be sent, the user may select a Conceal button to conceal the displayed list.

The user then inputs a subject for the contents of the note in the subject input window 431, selects any one of editing modes (e.g., HTML editing, Source editing, and Text) to edit the contents of the note in the editing-mode selection window 432, and inputs the contents of the note in the note-content input window 435, like composing a common e-mail.

The user may edit the contents of the note input in the note-content input window 435, in the editing-menu window 433, and add various functions (e.g., image inserting, multimedia inserting, and linking) in the function-menu window 434.

Additionally, when desiring to attach files stored in the user terminal 100a to 100n to the note to be sent, the user is allowed to add and delete files to be attached within an allowed file size in the attached-file management window 440.

Finally, the user can send a desired common note to the selected group or users at one time by clicking on the Send button of the main web-note window.

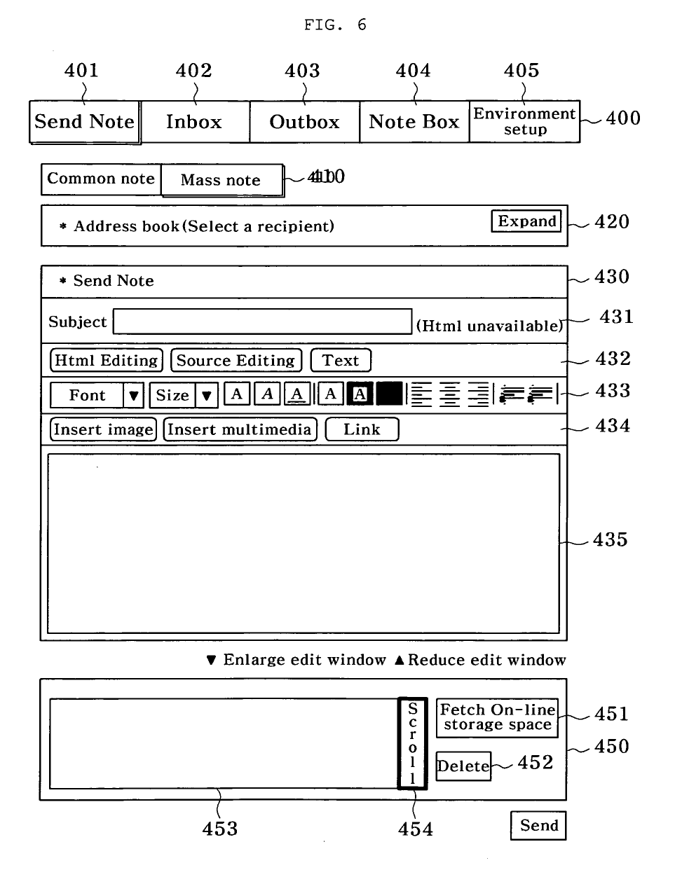

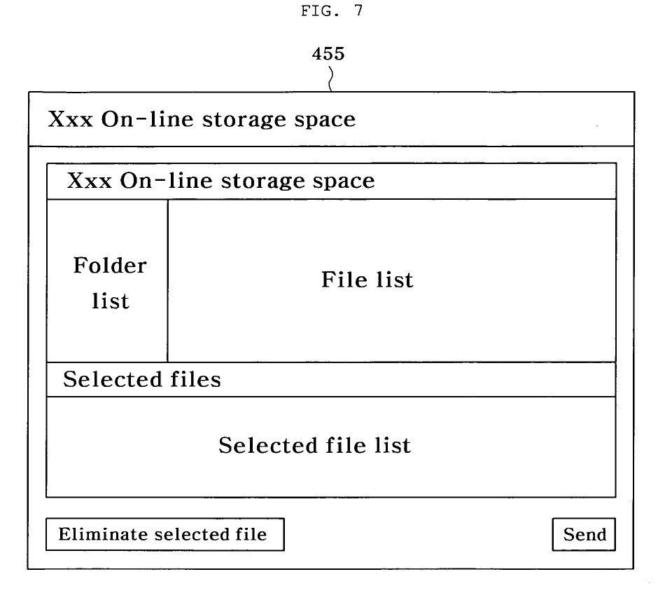

FIG. 6 illustrates an Internet web page displayed when the mass-note mode of the Send Note menu is selected according to an exemplary embodiment of the present invention, and FIG. 7 illustrates an Internet web page displayed when an On-line storage space fetch button of FIG. 6 is clicked on, in which the user accessing the service system 300 selects the mass-note mode and sends a note to other users in a group at one time.

Referring to FIG. 6, when the user desires to send a desired mass note to any group consisting of a number of predetermined users in the displayed main web-note window, the user selects the Send Note button 401 of the menu selection window 400 and then selects the Mass-note button 412 of the note-mode selection window 410.

The user then selects a group or users to which the note is to be sent in the address-book management window 420, and inputs and edits the contents of the note in the Send Note edit window 430, as in the previously-described common-note mode.

In the mass-note mode, an On-line storage space management window 450 rather than the attached-file management window 440 is displayed, unlike the previously-described common-note mode.

The On-line storage space management window 450 includes an On-line storage space fetch button 451 for fetching mass files from a network hard disk of the service system 300 and attaching the mass files to the mass note, a Delete button 452 for deleting the attached mass files, an attached-file list window 453 for displaying a list of the attached mass files, and a scroll button 454 for scrolling a list of the attached mass files.

Here, when the user selects the On-line storage space fetch button 451 of the On-line storage space management window 450, a file management window 455 for managing files in an Internet storage disk already assigned to the user is displayed as shown in FIG. 7.

Files to be attached are displayed on the attached-file list window 453 of the On-line storage space management window 450 when the user selects the files and then clicks on the Send button on the displayed file management window 455.

Finally, the user is allowed to send the desired mass note to the selected group or other users at the same time by clicking on the Send button of the main web-note window.

Here, the term “On-line storage space” refers to a network hard disk for e-mail utilization or back-up on the Internet.

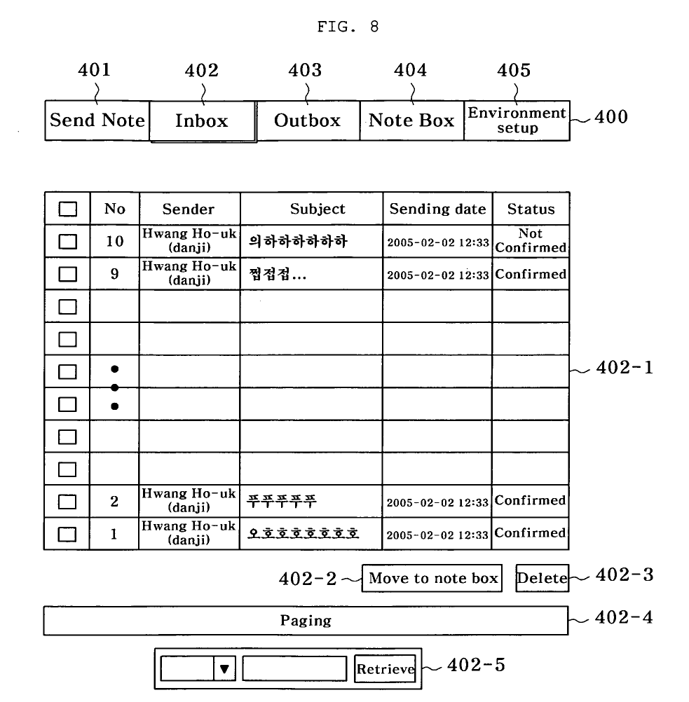

FIGS. 8 to 11 illustrate Internet web pages displayed when an inbox menu is selected according to an exemplary embodiment of the present invention.

Referring to FIGS. 8 to 11, when desiring to view notes received from other users in the group to which the user belongs in the displayed main web-note window, the user clicks on the Inbox button 402 of the menu selection window 400 to display a received-note table 402-1 showing a list of received notes.

A Move to Box button 402-2 for selecting the received notes in the received-note table 402-1 and moving the notes to the note box 404, a Delete button 402-3 for selecting the received notes in the received-note table 402-1 and deleting the notes, a page display window 402-4 for displaying a list of received notes displayed in the received-note table 402-1 on a page, and a retrieval window 402-5 for retrieving the received notes in the received-note table 402-1, may also be displayed.

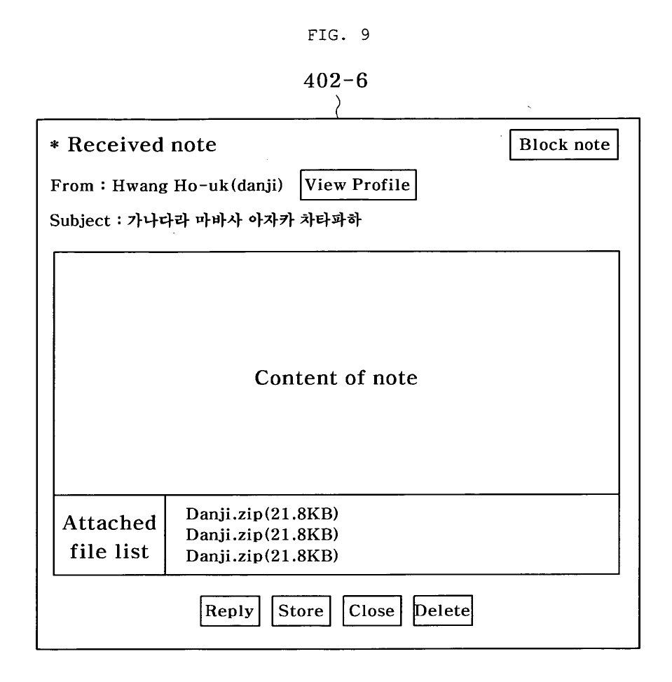

When desiring to view contents of the received notes displayed in the received-note table 402-1, the user selects a desired list from the received-note lists in the received-note table 402-1 to activate the received-note window 402-6 showing the contents of the selected received-notes, as shown in FIG. 9.

The received-note window 402-6 may display a sender's name, a sent note's subject, a sent note's contents, and an attached-file list.

The received-note window 402-6 may further include a Block Note button for blocking notes from a sender so that the user does not receive notes, a View Profile button for viewing a profile of the sender, a Reply button for replying to the sender, a Store button for storing the selected received-note in the note box 404, a Close button for closing the activated received-note window 402-6, a Delete button for deleting the selected received-note, etc.

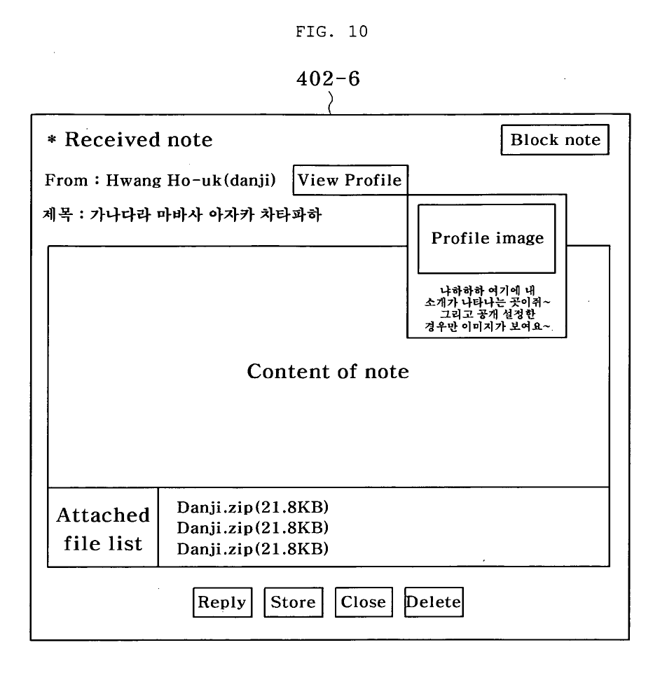

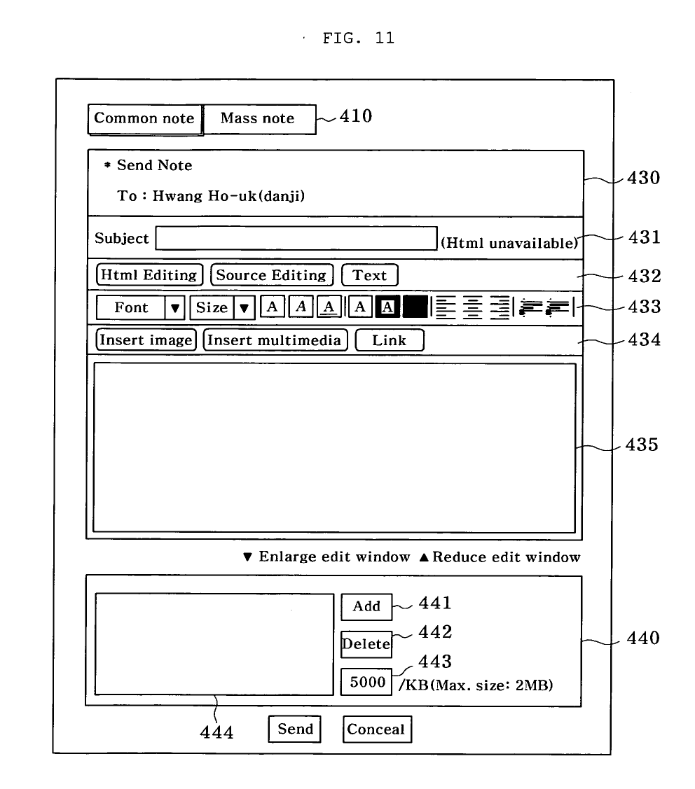

The user may view the sender's profile and image as shown in FIG. 10 by clicking on the View Profile button. When the Reply button is clicked on, the selected sender is set as a recipient as shown in FIG. 11 and the web-note window is activated as in FIG. 2 so that the user sends a desired note to the sender, similarly to in the previously-described note sending method.

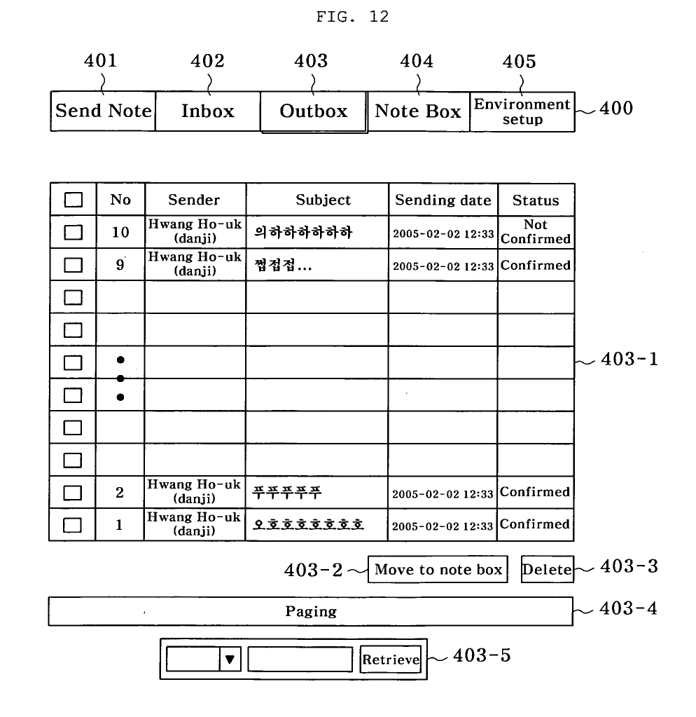

FIG. 12 illustrates an Internet web page displayed when an outbox menu is selected according to an exemplary embodiment of the present invention.

Referring to FIG. 12, when desiring to view a note sent to other users in the group to which the user belongs in the displayed main web-note window, the user clicks on the Outbox button 403 of the menu selection window 400 to display a sent-note table 403-1 showing a list of sent notes.

A Move to Box button 403-2 for selecting sent notes displayed in the sent-note table 403-1 and moving the notes to the note box 404, a Delete button 403-3 for selecting the sent notes displayed in the sent-note table 403-1 and deleting the notes, a page display window 403-4 for displaying a list of sent notes displayed in the sent-note table 403-1 on a page, and a retrieval window 403-5 for retrieving the sent notes displayed in the sent-note table 403-1, may also be displayed.

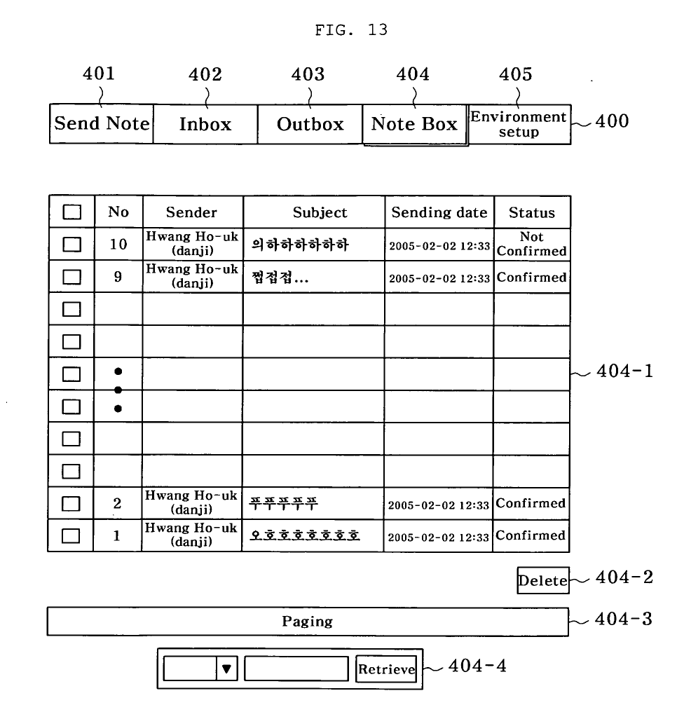

FIG. 13 illustrates an Internet web page displayed when a note box menu is selected according to an exemplary embodiment of the present invention.

Referring to FIG. 13, when desiring to view the received notes or sent notes, which have been stored in response to a user's selection, in the displayed main web-note window, the user clicks on the note box button 404 of the menu selection window 400 to display a stored-note table 404-1 showing a list of the received or sent notes stored in the note box 404.

A Delete button 404-2 for selecting and deleting notes displayed in the stored-note table 404-1, a page display window 404-3 for displaying a list of the notes displayed in the stored-note table 404-1 on a page, and a retrieval window 404-4 for retrieving the notes displayed in the stored-note table 404-1, may also be displayed.

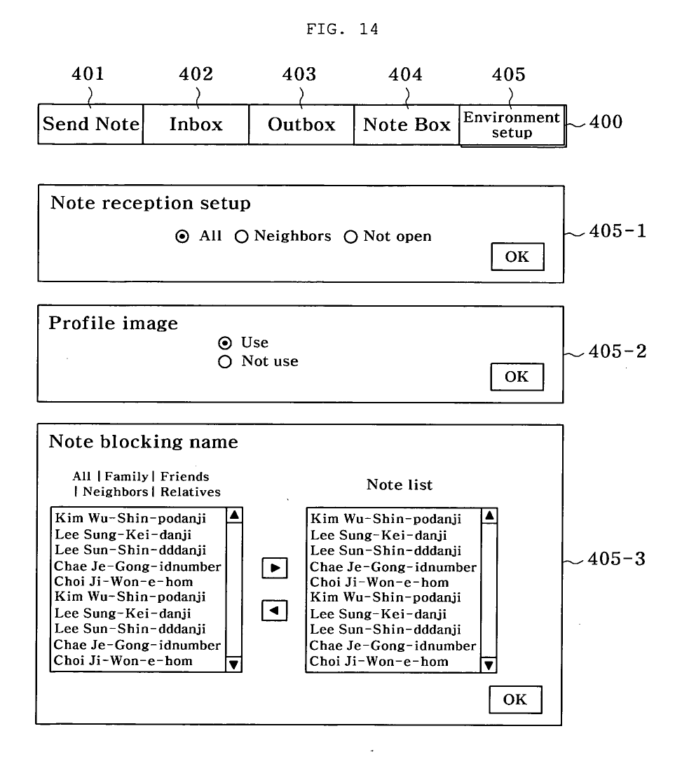

FIG. 14 illustrates an Internet web page displayed when an environment setup menu is selected according to an exemplary embodiment of the present invention.

Referring to FIG. 14, when desiring to set up various environments in the displayed main web-note window, the user clicks on the environment setup button 405 of the menu selection window 400 to display a note reception setup window 405-1 for selecting an object (e.g., All, Neighbor, Not open, etc.) to which the note is to be sent, a profile-image use window 405-2 for selecting whether the user uses a profile image (e.g., Use or Don't Use), and a block note name window 405-3 for displaying names of notes blocked by the user and a list of the notes.

With the previously-described method for transmitting a multimedia note using a concept of groupware according to an embodiment of the present invention, a user can group related contacts and selectively send a message to them at one time. For example, the user can selectively send a message to family, relatives, friends or neighbors. In the case of friends, the user can further group his/her friends, for example, as school friends, military friends, club friends, and company, and send the message to a selected group at one time.

For example, in the case of a group buying a town provided by Ehome (www.ehome.co.kr), a user may group members to selectively send information.

Further, all companies requiring customer management, such as companies performing business to consumer (B2C), can selectively deliver information to customers as much as they want by providing the customers with a “platform” such as Ehome (www.ehome.co.kr) and connecting the platform to their customer relation management (CRM) system, thereby increasing an information access rate by the customers and readability.

For example, companies can ensure considerable cost competitiveness, speed, and information readability by utilizing, for various bills, the mass note of the present invention, rather than e-mail which users tend not to open. Particularly, distribution companies (e.g., home shopping companies) can induce so-called “visiting commercial transaction” using moving images, thereby increasing a purchasing rate.

Further, churches and other organizations may develop need of the mass note of the present invention in order to send a number of messages to their members.

Churches and other organizations require several billion to several ten billion won to build groupware, and have problems using groupware because it is not expandable to the outside.

Further, the general organizations still send information through the traditional mail system, which is time and cost inefficient. On the national level, such traditional mails cause excessive waste, contributing to waste disposal costs exceeding twelve trillion won per year in Korea.

To solve these problems, according to the method for transmitting a multimedia note using a concept of groupware of the present invention, a daily simple message and a moving image of a pastor preaching are sent to recipients via a homepage link to be repeatedly viewed in their room, and recipients and organization members become neighbors and give and receive news and messages through the mass notes, thereby increasing solidarity and connectedness.

In addition, apartment complexes and local governments may require the mass note of the present invention. For example, apartment complexes and local governments may utilize the mass note of the present invention as a tool for posting various notices such as management expense reports and tax notices, soliciting opinions, etc. Meanwhile, local governments may deliver a periodic communiqué to citizens through moving images, and citizens may offer their opinions, thereby leading to citizens' electronic participation in government.

Furthermore, the mass note of the present invention can be very useful in schools, academies, etc. For example, schools, academies, etc. may send homework and other materials as attached files through the mass note. Further, academies may send moving-image lecture scenes to students'rooms through the mass note of the present invention so that the students can repeatedly learn the content of lecture at a desired time, thereby increasing learning efficiency.

Particularly, the present invention eliminates the need to communicate with students' parents via traditional mail, thereby saving considerable time and money. With the present invention, parents can actively take part in school work, thereby opening a so-called “open education” age. In addition, inappropriate spam mail can be blocked, thereby overcoming certain dangers the Internet poses to today's youth.

Besides, the mass note of the present invention provides advantages to numerous clubs, alumni associations, and groups in terms of cost, time, and efficiency.

Meanwhile, with the mass note of the present invention, users can receive only desired information from a number of groups or companies to which the users belong. Accordingly, the users do not receive spam mail and can always refuse to receive unwanted notes by activating “Block Note.” That is, the user can directly make an Internet clean area.

The method for transmitting a multimedia note using a concept of groupware according to an embodiment of the present invention can be embodied as a computer program recorded on a computer-readable recording medium.

As described above, the method for transmitting a multimedia note using a concept of groupware and the system therefor allow a user to transmit and receive information in real time, like an instant messaging program, and to send a large quantity of information to a group to which the user belongs, and can effectively block spam mail, by combining a source editing function of an e-mail service, the maneuverability of an instant messaging program, and a mass delivery function of groupware.

While the present invention has been described with reference to exemplary embodiments thereof, it will be understood by those skilled in the art that various changes in from and detail may be made therein without departing from the scope of the present invention as defined by the following claims.

What is claimed is:

1. A method for transmitting a note between users in a groupware service system environment within cyberspace based on an Internet network, the method comprising:
(a) accessing, by a user, a web server of a groupware service system via the Internet to log on to the system; and
(b) performing e-mail-style multimedia note transmission service having a source editing function to send, at one time, a multimedia note to other users in a group to which the user belongs.

2. The method of claim 1, wherein the multimedia note transmission service in step (b) is performed by:
(b1) selectively sending, by the user, a desired multimedia note to a number of predetermined groups; and
(b2) managing notes received from other users in the group to which the user belongs.

3. The method of claim 2, wherein step (b1) comprises:
(b1-1) selecting either a general-note mode or a mass-note mode;
(b1-2) selecting, on a group-by-group basis, a list of other users in the group to which the user belongs; and
(b1-3) editing a note to be sent.

4. The method of claim 3, further comprising managing files stored in a user On-line storage space when the mass-note mode is selected in step (b1-1), wherein the managing of the files comprises:
(b1-1-1) fetching a mass file from a network hard disk of the service system and attaching the mass file when the user desires to attach the mass file;
(b1-1-2) selecting and deleting the attached mass file when the user desires to delete the attached mass file;
(b1-1-3) displaying a list of the attached mass files; and
(b1-1-4) scrolling the list of the attached mass files.

5. The method of claim 3, wherein step (b1-3) comprises:
(b1-3-1) inputting a subject for the contents of a note to be sent;
(b1-3-2) selecting one of various editing modes for the contents of the note;
(b1-3-3) editing the contents of the note;
(b1-3-4) adding various functions to the contents of the note; and
(b1-3-5) inputting the contents of the note.

6. The method of claim 5, wherein step (b1-3-2) comprises:
(b1-3-2-1) editing the contents of the note to be sent in an HTML format;
(b1-3-2-2) editing the contents of the note in a source format; and
(b1-3-2-3) editing the contents of the note in a text format.

7. The method of claim 5, wherein step (b1-3-4) comprises:
(b1-3-4-1) inserting various images into the contents of the note to be sent;
(b1-3-4-2) inserting various multimedia into the contents of the note; and
(b1-3-4-3) linking a desired web page to the contents of the note.

8. The method of claim 2, wherein step (b2) comprises:
(b2-1) displaying a list of received notes in the form of a table;
(b2-2) when the user desires to store at least one of the received notes, selecting the note and moving it to a note box;
(b2-3) when the user desires to delete at least one of the received notes, selecting and deleting it; and
(b2-4) displaying the list of received notes on a page.

9. The method of claim 8, further comprising selecting a received-note list that the user desires to view from the list of received notes in step (b2-1), wherein the selecting of the received-note list comprises displaying the contents of the selected received-note, the contents including a sender's name, a sent-note's subject, sent-note's contents, and an attached-file list.

10. The method of claim 9, further comprising blocking other notes when the user desires not to receive anymore notes from the sender.

11. A computer-readable recording medium having a program recorded thereon, the program enabling the method of any one of claims 1 to 10 to be executed by the computer.

12. A system for transmitting notes between users in a groupware service system environment within cyberspace based on an Internet network, the method comprising:
(a) a user authenticating unit for allowing a user to access a web server of a groupware service system via the Internet and to log on to the system; and
(b) a service providing unit for performing e-mail-style multimedia note transmission service having a source editing function to send, at one time, a multimedia note to other users in a group to which the user belongs.

13. The system of claim 12, wherein the service providing unit comprises:
a Send Note function unit for allowing the user to selectively send a desired multimedia note to a number of predetermined groups; and
an inbox function unit for managing notes received from other users in the group to which the user belongs.

14. The system of claim 13, wherein the Send Note function unit comprises:
a note-mode selection unit for selecting either a general-note mode or a mass-note mode;
an address-book management unit for selecting, on a group-by-group basis, a list of other users in the group to which the user belongs; and
a Send Note editing unit for editing a note to be sent.

15. The system of claim 14, further comprising an On-line storage space management unit for managing files stored in a user On-line storage space when the mass-note mode is selected, wherein the On-line storage space management unit comprises:
an On-line storage space fetch unit for fetching a mass file from a network hard disk of the service system and attaching the mass file to the note;
a deleting unit for deleting the attached mass file;
an attached-file list display unit for displaying a list of the attached mass files; and
a scroll unit for scrolling the list of the attached mass files.

16. The system of claim 14, wherein the Send Note editing unit comprises:
a note-content subject input unit for inputting a subject for the contents of a note to be sent;
an editing-mode selection unit for selecting one of various editing modes for the contents of the note;
a note-content editing menu unit for editing the contents of the note;
a function-menu unit for adding various functions to the contents of the note; and
a note-content input unit for inputting the contents of the note.

17. The system of claim 16, wherein the editing-mode selection unit comprises:
an HTML editing unit for editing the contents of the note to be sent in an HTML format;
a source editing unit for editing the contents of the note in a source format; and
a text editing unit for editing the contents of the note in a text format.

18. The system of claim 16, wherein the function-menu unit comprises:
an image insert function unit for inserting various images into the contents of the note to be sent;
a multimedia insert function unit for inserting various multimedia into the contents of the note; and
a link function unit for linking a desired web page to the contents of the note.

19. The system of claim 13, wherein the inbox function unit comprises:
a received-note table display unit for displaying a list of received notes in the form of a table;
a Move to Box unit for selecting at least one of the received notes and moving it to a note box;
a deleting unit for selecting and deleting at least one of the received notes; and
a page display unit for displaying the list of received notes on a page.

20. The system of claim 19, wherein when a received-note that the user desires to view is selected from the list of received notes, a received-note unit for displaying the contents of the selected received-note is activated, the received-note unit displaying a sender's name, a sent-note's subject, sent-note's contents, and an attached-file list.

21. The system of claim 20, wherein the received-note unit further comprises a note blocking function unit for blocking further notes sent by the sender.
